(19) United States
(12) Patent Application Publication
(10) Pub. No.: US 2007/0150141 A1
(43) Pub. Date: Jun. 28, 2007

(54) Vehicle travelling data recording device

(76) Inventor: Rober Lo, Taichung City (TW)

Correspondence Address: Rober Lo, P.O. Box 44-2049, Taipei, 10668, omitted

(21) Appl. No.: 11/500,887

(22) Filed: Aug. 9, 2006

(30) Foreign Application Priority Data
Dec. 9, 2005 (TW) 094221560

(51) Int. Cl. G06F 7/00

(52) U.S. Cl. 701/35

(57) ABSTRACT

A vehicle travelling data recording device includes a digital video recorder, a vehicle travelling speed recorder, a vehicle travelling condition recorder and a removable hard disk drive. Synchronously recording the vehicle travelling condition, the vehicle travelling speed and the signal structure and operation condition can achieve the object of reducing the vehicle travelling strife.

### BACKGROUND OF THE INVENTION

(1) Field of the Invention

The invention relates to a digital vehicle travelling data recording device capable of synchronously recording the video and recording the vehicle travelling condition.

(2) Description of the Prior Art

When the current vehicle is running, the complicated walking causes various conditions. For example, the driver may contravene the traffic rule and is thus denounced by the police, or a traffic accident may occur. However, the exculpation usually cannot be made to cause the conflict between both sides. Thus, it is very important to provide a device capable of effectively recording vehicle travelling data.

In view of this, the inventor makes deep researches to develop the vehicle travelling data recording device in conjunction with actual experimental test. It is found that the predetermined utility target can be effectively achieved.

### SUMMARY OF THE INVENTION

The vehicle travelling data recording device includes a digital video recorder, a vehicle travelling speed recorder, a vehicle travelling condition recorder and a removable hard disk drive.

The vehicle travelling speed recorder is synchronously connected to an odometer of the vehicle and synchronously enables the digital video recorder as the vehicle starts to run in order to record frames inside and outside the travelling vehicle and record the travelling speed of the vehicle.

The vehicle travelling condition recorder is synchronously connected to the digital video recorder and each signal structure of the vehicle, and completely records the vehicle travelling condition, such as the condition of a direction indicator, a brake lamp, a reversing lights or a stop bell.

The removable hard disk drive stores the recorded frames and the recorded data of the vehicle travelling condition, which are provided by the digital video recorder, the vehicle travelling speed recorder and the vehicle travelling condition recorder.

Synchronously recording the vehicle travelling condition, the vehicle travelling speed, the signal structure and the operation condition can reduce the incident during vehicle travelling.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a block diagram showing a structure according to a preferred embodiment of the invention.

FIG. 2 is a pictorially exterior view showing a removable hard disk drive of the invention.

FIG. 3 is a schematically pictorially exploded view showing the structure of FIG. 2.

FIG. 4 is a schematically cross-sectional view showing the structure of FIG. 2.

### DETAILED DESCRIPTION OF THE PREFERRED EMBODIMENTS

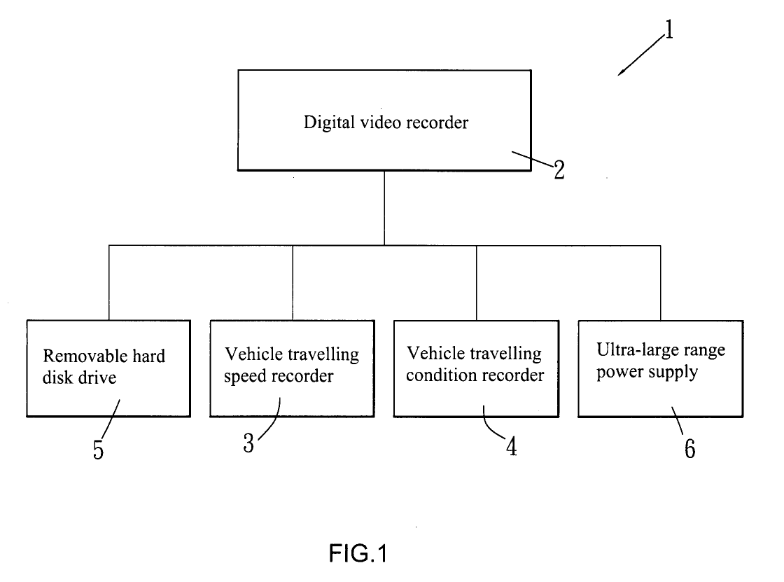

FIG. 1 is a block diagram showing a structure according to a preferred embodiment of the invention. Referring to FIG. 1, the vehicle travelling data recording device (1) includes a digital video recorder (2), a vehicle travelling speed recorder (3), a vehicle travelling condition recorder (4), a removable hard disk drive (5) and an ultra-large range power supply (6).

The vehicle travelling speed recorder (3) is synchronously connected to an odometer of the vehicle and synchronously enables the digital video recorder (2) and records frames inside and outside the travelling vehicle and travelling speed of the vehicle as the vehicle starts to run.

The vehicle travelling condition recorder (4) is synchronously connected to the digital video recorder (2) and each signal structure of the vehicle. The vehicle travelling condition recorder (4) completely records a vehicle travelling condition, including a condition of a direction indicator, a brake lamp, a reversing light or a stop bell.

The removable hard disk drive (5) stores the recorded frames and the recorded vehicle travelling condition, which are provided by the digital video recorder (2), the vehicle travelling speed recorder (3) and the vehicle travelling condition recorder (4).

In addition, the invention uses the vehicle battery as the power. In order to prevent the too-great power change from influencing the function of the electronic element or damaging the electronic element, the vehicle travelling data recording device (1) of the invention particularly has an ultra-large range power supply (6) for supplying a stable voltage ranging from 8 to 32 volts. The too-great power change may be caused by the voltage drop induced when the engine is started by the large current or when the air conditioning device is started by the large current, or caused by the high voltage induced by the failure of the voltage stabilizer of the generator.

Also, the removable hard disk drive surely has the convenient mobility according to the experience. However, the hard disk drive itself is an electronic product with high precision, the pickup head assembly are formed by combining multiple pickup heads, which are arranged vertically. Because the pickup heads have to be moved back and forth at the high speed, no jitter can be produced and the heads have to be precisely moved to the addresses without any minor error in the perpendicularity. In addition, the pickup heads cannot be loose or tilting, or otherwise the track seeking cannot be performed. This is why the hard disk drive cannot be collided. When the conventional removable hard disk drive is being carried, it tends to be shaken and collided. However, the conventional removable box cannot provide any protection function of absorbing vibration such that the fault rate of the removable hard disk drive is always kept high. However, no suitable vibration absorbing method is currently found, which becomes a big trouble for the user.

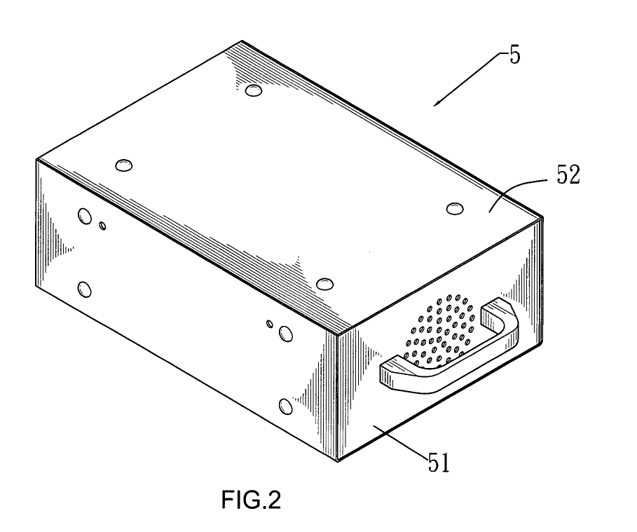

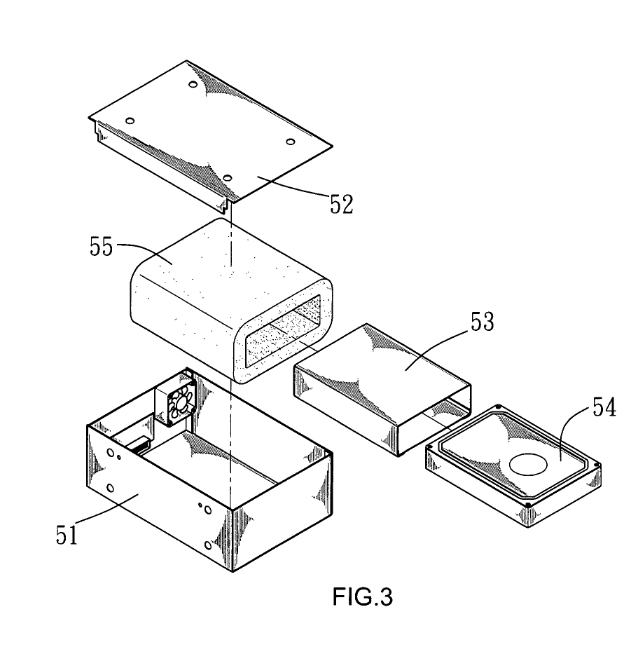

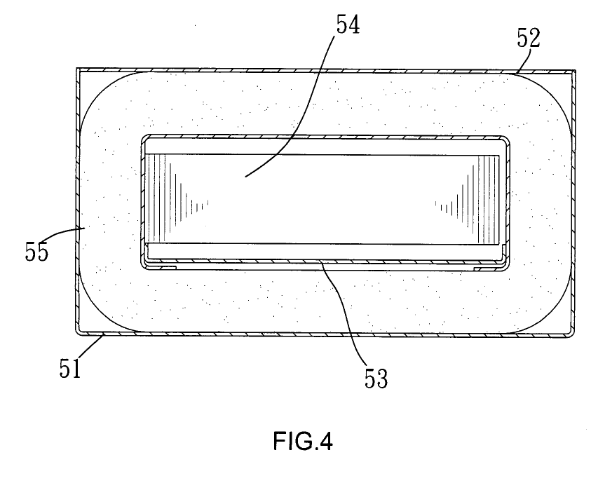

FIG. 2 is a pictorially exterior view showing a removable hard disk drive (5) of the invention. FIG. 3 is a schematically pictorially exploded view showing the structure of FIG. 2. Referring to FIGS. 2 and 3, the invention includes a removable box (51) and a hard disk drive (54). The removable box (51) has an upper cover (52) and a hollow mounting seat (53) inside the box. The hard disk drive (54) is mounted on an inner peripheral space. Also, the mounting seat (53) and the hard disk drive (54) are filled into an opening of an inert sponge ring (55), and the combination of the parts 53, 54 and 55 are placed in the inner peripheral space of the removable box (51). The upper cover (52) may be closed on the removable box (51) to form an integrated entity. FIG. 4 is a schematic illustration showing a cross-section of the structure.

Because the inert sponge has the function of slow bounce, the hard disk drive (54) never contacts the box directly when the hard disk drive (54) is covered in the inert sponge ring (55). When the box is carried and the conditions of collision and shake occur, the withstanding external force makes the inner mounting seat (53) and the inner hard disk drive (54) to press the outer inert sponge ring (55). The property of slow bounce can effectively absorb the external force such that the hard disk drive (54) is free from being influenced by the external force, the pickup head is free from being damaged easily, and the best protection effect of absorbing the vibration of the hard disk drive can be achieved.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. A vehicle travelling data recording device powered by a battery of a vehicle, the device comprising a digital video recorder, a vehicle travelling speed recorder, a vehicle travelling condition recorder and a removable hard disk drive, wherein:
the vehicle travelling speed recorder is synchronously connected to an odometer of the vehicle, and synchronously enables the digital video recorder to record frames inside and outside the travelling vehicle and records a travelling speed of the vehicle as the vehicle starts to run;
the vehicle travelling condition recorder is synchronously connected to the digital video recorder and each signal structure of the vehicle, and completely records a vehicle travelling condition, comprising a condition of a direction indicator, a brake lamp, a reversing light or a stop bell; and
the removable hard disk drive stores the recorded frames and the recorded vehicle travelling condition, which are provided by the digital video recorder, the vehicle travelling speed recorder and the vehicle travelling condition recorder.

2. The device according to claim 1, further comprising an ultra-large range power supply for supplying a stable voltage ranging from 8 to 32 volts to prevent a voltage drop, which is produced by an instantaneously large current for starting the vehicle or an assembly of the vehicle, from damaging electronic elements of the vehicle travelling data recording device.

3. The device according to claim 1, wherein:
the removable hard disk drive comprises a removable box and a hard disk drive, and the removable box is composed of a body and an upper cover;
a hollow mounting seat is disposed in the removable box body, and the hard disk drive is fixed in an inner periphery space of the removable box body;
the mounting seat and the hard disk drive are filled into an opening of an inert sponge ring;
a combination of the mounting seat, the hard disk drive and the inert sponge ring is placed into the inner periphery space of the removable box; and
the inert sponge ring having a slow bounce property effectively absorbs an external force to prevent the removable hard disk drive from vibration.
